(19) United States
(12) Patent Application Publication
(10) Pub. No.: US 2005/0004833 A1
(43) Pub. Date: Jan. 6, 2005

(54) Method and system for integrated uncertainty analysis

(75) Inventors: Gregory J. McRae, Winchester, MA (US); Cheng Wang, San Diego, CA (US)

Correspondence Address: FOLEY & LARDNER, P.O. BOX 80278, SAN DIEGO, CA, 92138-0278, US

(73) Assignee: Reaction Design, LLC

(21) Appl. No.: 10/613,623

(22) Filed: Jul. 3, 2003

(51) Int. Cl. G06F 17/60

(52) U.S. Cl. 705/11

(57) ABSTRACT

A system and a method are provided for performing an integrated uncertainty analysis on a system having interacting modules. The interaction of the modules includes data transfer between the modules with the output of one module being indicative of the input of another module. An uncertainty analysis is performed on each module based on given probability density functions of each input to the module. The uncertainty analysis may include developing a deterministically equivalent model for one or more modules. Data may be provided from one module to another in a uniform format. Thus, two or more modules may be integrated with uncertainties in the inputs of one module being effectively propagated to the inputs of another module. A plurality of modules may thus be modeled as a single integrated system. The integrated system may be replaced with a deterministically equivalent model, preferably of a further reduced order. In this manner, key uncertainties in particular inputs may be isolated. Once these inputs are identified, resources may be effectively allocated to minimize the impact of those inputs on the variability of the results.

### FIELD OF THE INVENTION

The invention relates to analysis of uncertainties in a system. More particularly, the invention provides a method and a system for analyzing uncertainties for a set of modules in a system in an integrated manner.

### BACKGROUND

Major challenges facing industry, particularly manufacturing industries, include reducing lengthy time to market and improving the performance of existing capital assets. For example, in the case of the chemical industry, reducing the typical 5-7-year development cycle for a product may result in significant advantages in the market. In industries with relatively short cycles, enormous competitive pressures remain to accelerate the development process.

The development or improvement of a production facility generally involves several basic phases. These phases may include a technical feasibility analysis, detailed studies of the processes, pilot scale testing, detailed engineering design, building a facility, and continuous improvement of the facility. Many commercial software packages are available for various industries to assist in many of these phases. For example, for the chemical industry, computational fluid dynamics simulation packages are readily available. Further, project scheduling software packages are available for general and specific scheduling.

One concern in each phase of the development cycle is the level of uncertainties involved. The commercial packages may generally provide a point solution for a set of inputs. In order to account for uncertainties at each level, an uncertainty analysis may be required for each step or process. Such an uncertainty analysis may be required to determine the source of variations in the result of each step or process.

Uncertainty analyses may be performed using many known methods. For example, a Monte Carlo analysis may be performed for each step or process of a system. A Monte Carlo analysis may require a large number of simulations to be executed with the inputs being varied according to their underlying probability density function. The result of the Monte Carlo analysis is a distribution of the results as a function of the variations in the inputs. On a large-scale project, however, such an analysis may be cumbersome for some applications.

U.S. Pat. No. 6,173,240 discloses a method by which Monte Carlo sampling may be reduced. However, such an analysis provides results for only a single step.

### SUMMARY OF THE INVENTION

The disclosed systems and methods are directed to analysis of uncertainties in a system. Uncertainties in the inputs of a system and their effect on the outputs may be efficiently analyzed by, for example, generating a simplified, yet accurate, model of the system.

Additionally, the uncertainties in several components of the system may be analyzed together, rather than individually, thereby allowing an efficient analysis of the system as a whole.

According to an aspect of the invention, a method of analyzing uncertainties in a system having at least two modules includes propagating an uncertainty distribution associated with each of a set of inputs through a module to produce a description of the uncertainty in a set of outputs of said module.

Uncertainties may be uncontrollable variations in the inputs that may cause variations in the outputs. Uncertainties may be distributed continuously or discretely over a range of Values.

A module may be any component of a system of processes, mechanisms, or algorithms. A module may include a process, a sub-process, a mechanism, an algorithm step, a calculation, or a software package simulation. Further, a module may be a part of or one or more processes, sub-processes, mechanisms, algorithm steps, calculations, simulations or other components.

Inputs are parameters that are used by one or more modules. Inputs may include, for example, internal or external parameters that may be preset, provided by a user, or provided by another module.

Outputs are parameters that are generated by one or more modules. Outputs may include parameters that are generated by a module in response to one or more inputs.

The method further includes generating a probabilistically equivalent model of the module, the equivalent model producing a model of the outputs.

The probabilistically equivalent model may be a model of a module that is less complex yet produces similar outputs for a given set of inputs. Thus, the model of the outputs generally approximates the set of outputs.

The method further includes providing the model of the outputs in a common data architecture for use as inputs by any other module in the system.

The common data architecture may be a format for presenting the data to any other module in the system in such a manner that it is readily acceptable, including any information regarding uncertainty distribution of a particular variable.

According to another aspect of the invention, a method of analyzing uncertainties in a system includes substituting at least one of a plurality modules of a system with a corresponding probabilistically equivalent module model, the equivalent module model adapted to propagate uncertainties in inputs of the module to outputs of the module. The method further includes providing outputs of each of the modules in a common data architecture for use as inputs by any other module, the architecture adapted to propagate uncertainties in the outputs to the inputs of the other module. The method further includes substituting the plurality of modules with a single probabilistically equivalent system model for propagating uncertainties in system inputs to system outputs. The single probabilistically equivalent system model may be a single, less complex module that approximates the outputs, for a given set of inputs, of a system having two or more modules.

In another aspect of the invention, a system for generating an uncertainty analysis includes a module adapted to receive a set of inputs and to produce a set of outputs as a function of the inputs. Each of the inputs has an associated uncertainty distribution. As discussed above, the uncertainty distribution may be uncontrollable variations in the input parameter. The system may further include means for propagating the uncertainty distribution of the inputs through the module to produce an uncertainty in the outputs. The means for propagating uncertainties through the module may be a process or algorithm for determining the effects of the input uncertainties on the outputs, and may include, for example, a Monte Carlo or Pattern Search analysis. The system further includes means for generating a probabilistically equivalent model of the module, the equivalent model producing model outputs. The model outputs may be a set of outputs that approximate the outputs of the module given a set of inputs. The system further includes means for providing the outputs in a common data architecture for use as inputs by any other module in the system.

In a further aspect of the invention, a system of analyzing uncertainties in a system comprises means for generating a probabilistically equivalent module model for at least one of a plurality modules of a system. The equivalent module model is adapted to propagate uncertainties in inputs of the module to outputs of the module. The system further includes two or more interacting modules and means for providing outputs of each of the modules in a common data architecture for use as inputs by any other module. The architecture is adapted to propagate uncertainties in the outputs to the inputs of the other module. The system further includes means for generating a single probabilistically equivalent system model for the plurality of modules for propagating uncertainties in system inputs to system outputs.

According to a further aspect of the invention, a system for generating an uncertainty analysis includes a modeling module adapted to receive a set of inputs and to produce a set of outputs as a function of the inputs. Each of the inputs has an associated uncertainty distribution. The system includes an uncertainty propagation module adapted to propagate the uncertainty distribution of the inputs through the modeling module to produce an uncertainty in the outputs. An equivalent model generation module is adapted to generate a probabilistically equivalent model of the modeling module, The equivalent model produces model outputs. The system further includes an output generation module adapted to provide the outputs in a common data architecture for use as inputs by any other module.

According to a still further aspect of the invention, a system of analyzing uncertainties in a system comprises an equivalent model generation module adapted to generate a probabilistically equivalent subsystem model for at least one of a plurality of subsystems, the equivalent subsystem model being adapted to propagate uncertainties in inputs of the subsystem to outputs of the subsystem. The system further includes an output generation module adapted to provide outputs of each of the subsystems in a common data architecture for use as inputs by any other subsystem. The architecture is adapted to propagate uncertainties in the outputs to the inputs of the other subsystem. The output generation module may be a module adapted to generate output in a predetermined format which, for example, includes a readily acceptable means of propagating uncertainty information. The system also includes an equivalent system generation module adapted to generate a single probabilistically equivalent system model for the plurality of subsystems for propagating uncertainties in system inputs to system outputs.

In a yet further aspect of the invention, a program product comprises machine readable program code for causing a machine to perform method steps. The program product may be, for example, a software package adapted to run on a computer, PC, laptop, mainframe or similar computing device. The program product may contain instructions to be executed. The instructions may include a list of the method steps. The method steps include propagating an uncertainty distribution associated with each of a set of inputs through a module to produce an uncertainty in a set of outputs of the module. The method steps further include generating a probabilistically equivalent model of the module, the equivalent model producing a model of the outputs. The method steps also include providing the model of the outputs in a common data architecture for use as inputs by any other module in the system.

According to another aspect of the invention, a program product comprises machine readable program code for causing a machine to perform method steps, which include substituting at least one of a plurality modules of a system with a corresponding probabilistically equivalent module model. The equivalent module model is adapted to propagate uncertainties in inputs of the module to outputs of the module. The method steps also include providing outputs of each of the modules in a common data architecture for use as inputs by any other module. The architecture is adapted to propagate uncertainties in the outputs to the inputs of the other module. The method steps further include substituting the plurality of modules with a single probabilistically equivalent system model for propagating uncertainties in system inputs to system outputs.

In a preferred embodiment, the probabilistically equivalent model is a deterministically equivalent model. Similarly, the probabilistically equivalent system model may be a deterministically equivalent system model. A deterministically equivalent model may be developed using the steps described herein. The deterministically equivalent model may be a reduced-order model, which is less complex than the actual module in that relatively few inputs may be considered in generating the model outputs.

In a preferred embodiment, propagating the uncertainty distribution includes using a Monte Carlo or Pattern Search method. Monte Carlo and Pattern Search methods are well known in the art and may include perturbing each of a plurality of variables to obtain an output uncertainty.

At least one of the set of outputs may be incorporated into at least one of the set of inputs in a feedback loop. The feedback loop allows using an output of a module to determine one or more of the inputs of the module in, for example, an iterative process.

In a preferred embodiment, an optimization module is provided for optimizing an objective function. The optimization module is adapted to receive the system outputs and to vary the system inputs. The optimization module may be a software package or a routine for either maximizing or minimizing an objective function. The objective function may be any parameter or combination of parameters whose value is desired to be either minimized or maximized. In a preferred embodiment, the objective function is a weighted function of two or more output parameters. Thus, the variable to be minimized or maximized may be a combination of several parameters.

### BRIEF DESCRIPTION OF THE DRAWINGS

In the following, the invention will be explained in further detail with reference to the drawings, in which:

FIG. 1 illustrates a block diagram of a module in a system according to one embodiment of the invention;

FIG. 2 illustrates a system having a plurality of interacting modules and hierarchical levels of details according to one embodiment of the invention;

FIG. 3A-3E illustrate a process according to an embodiment of the invention by which a probabilistically equivalent model may be generated for one or more modules;

FIG. 4 illustrates an example of a deterministically equivalent model produced by the process illustrated in FIG. 3;

FIG. 5 illustrates an exemplary chemical system implementing an embodiment of the invention;

FIG. 6 illustrates a second exemplary chemical system implementing an embodiment of the invention;

FIG. 7A illustrates an exemplary common data architecture for use with a system according to an embodiment of the invention;

FIG. 7B illustrates an exemplary XML data file using the common data architecture of FIG. 7A; and

FIG. 8 illustrates a computer system on which embodiments of the invention may be implemented.

### DESCRIPTION OF CERTAIN EMBODIMENTS OF THE INVENTION

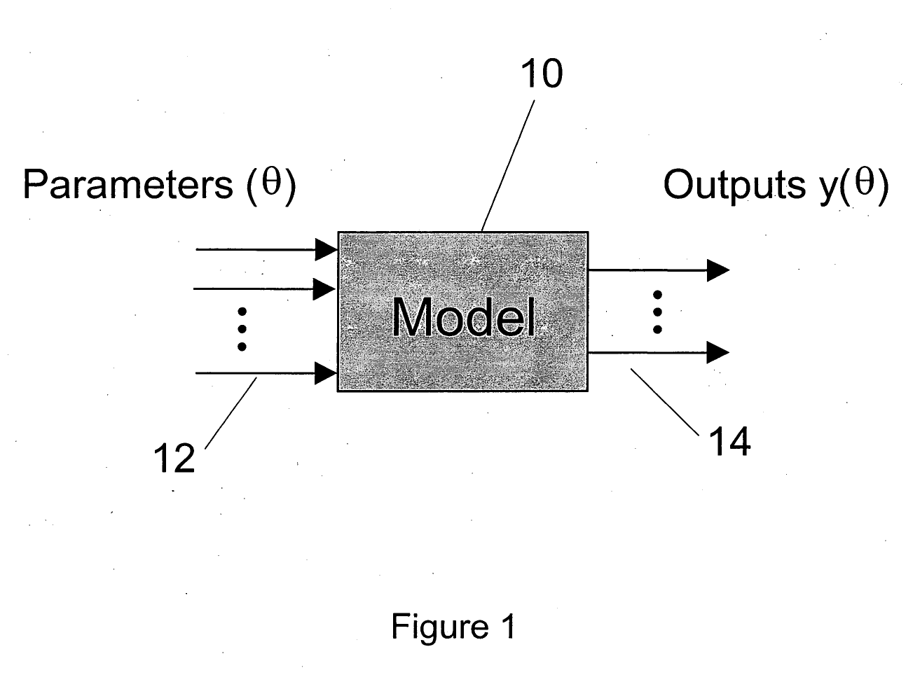

FIG. 1 illustrates a block diagram of a module in a system according to one embodiment of the invention. The module 10 may be a process or a device in a system. In one embodiment, the module 10 includes a portion of a process or a device. In another embodiment, the module 10 includes two or more processes or devices. The module 10 may be a simulation model, for example, of a device, a process, or a subsystem in the system. A commercial simulation tool may be used to simulate the model. The module 10 has a plurality of inputs θ 12 resulting in a plurality of outputs y(θ) 14. The inputs θ 12 may be a series of inputs defining, for example, the geometry of a chemical reactor or reactive properties of the reactants in a chemical reactor. Each input 12 may have a probability density function that may be represented as, for example, a Gaussian or normal distribution. The probability density function of each input 12 may effect the distribution of one or more outputs y 14.

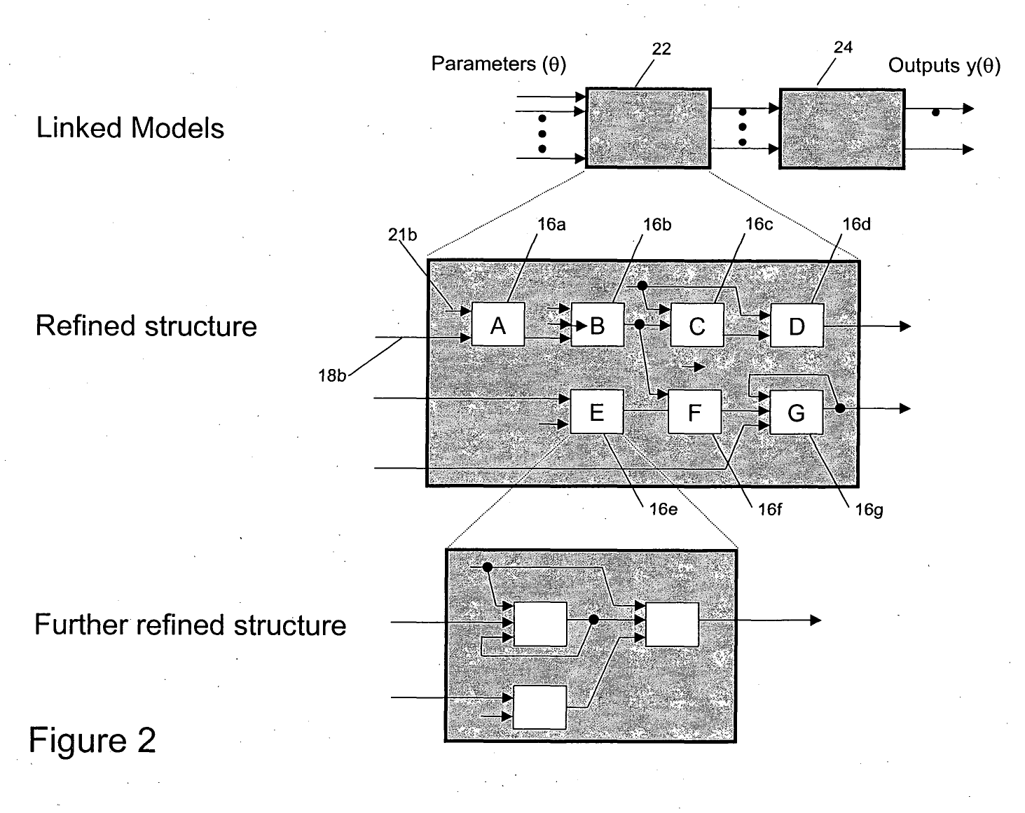

FIG. 2 illustrates a system according to one embodiment of the invention having a plurality of interacting modules 16a-g. As described above with reference to FIG. 1, each module has a plurality of inputs and outputs. As illustrated in FIG. 2, each module may have a one or more global inputs, including outputs from other modules, and one or more local inputs, such as global inputs 18b and local input 21b for module A 16a. The local inputs may be independent of the outputs of other modules.

FIG. 2 also illustrates an embodiment implementing the models in a hierarchical structure. At a highest level, a module 22 receiving input parameters is linked to a second module 24, which may provide system-level output parameters. At the next hierarchical level, the module 22 can be modeled with a refined structure having modules 16a-16g. Similarly, the second module 24 and additional modules may be modeled using a refined structure. At another hierarchical level, one or more modules in the refined structure may be represented in a further refined model. For example, FIG. 2 illustrates module E 16e being modeled with a further refined structure. It will be apparent to those skilled in the art that such a hierarchical structure may be provided with any practical number of levels as needed.

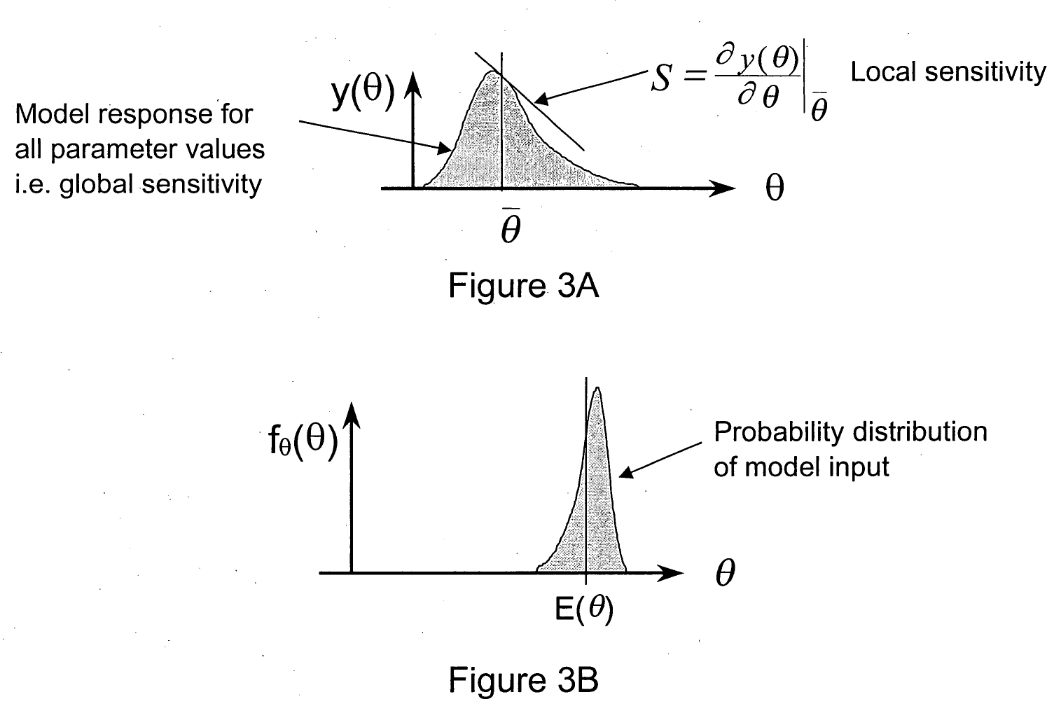

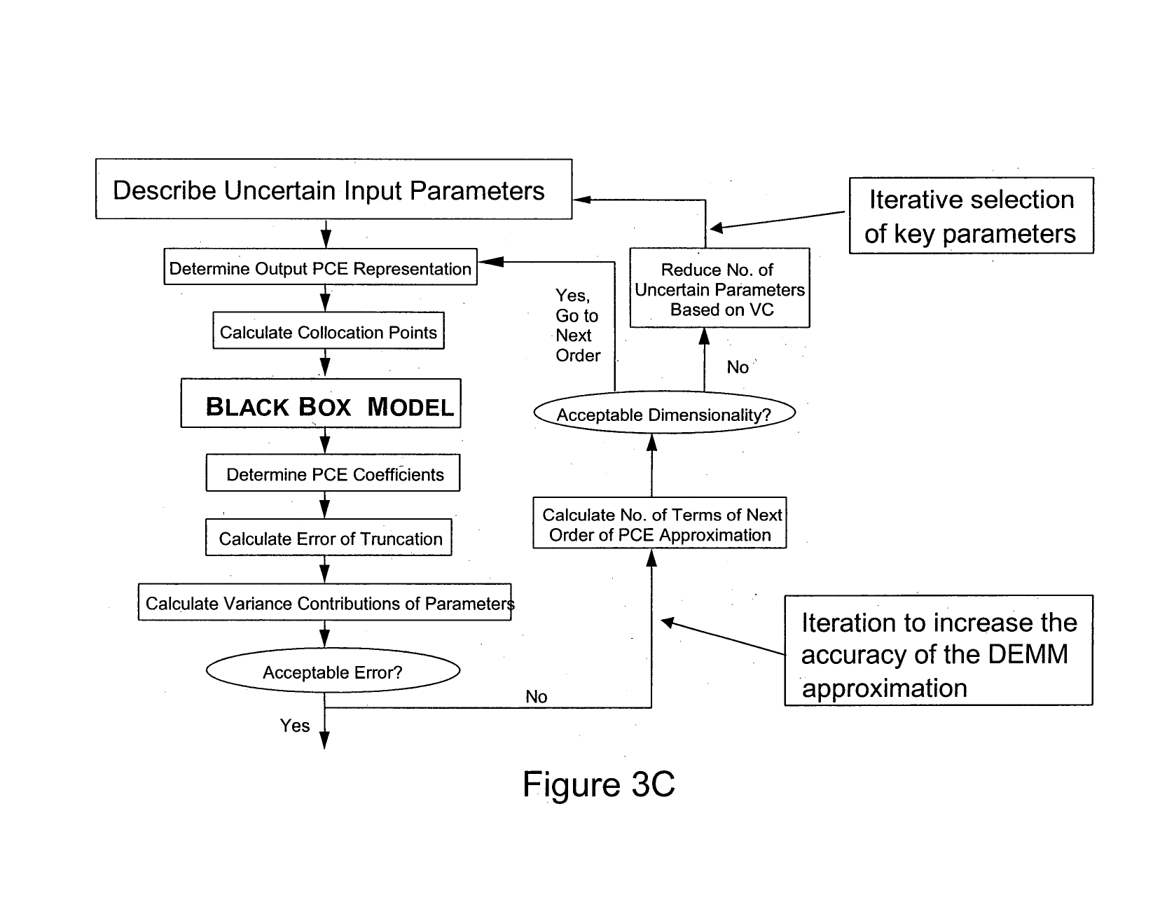

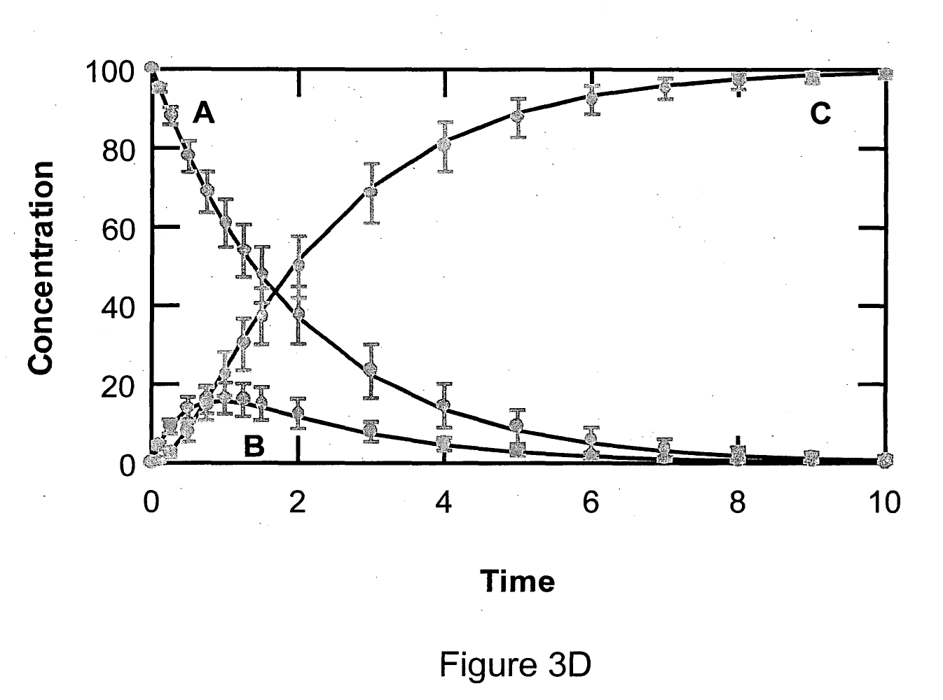

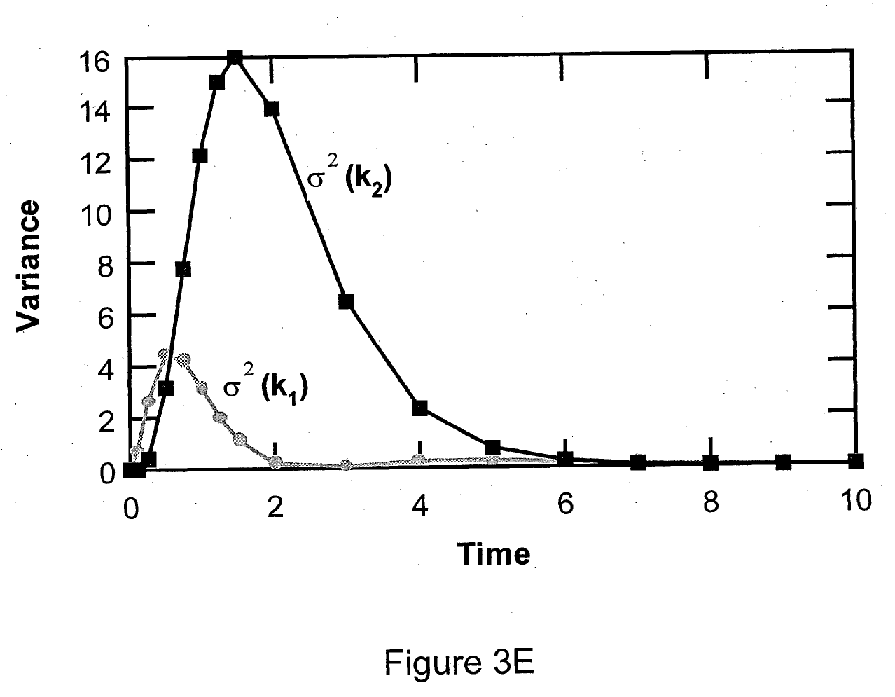

In one embodiment of the invention, each module 16a-g may be replaced with an equivalent representation. The representation is preferably a probabilistically equivalent model. Such models may be generated according to the method described below with reference to FIGS. 3A-3E.

Now, with reference to FIGS. 3A-3E, a process according to an embodiment of the invention by which a probabilistically equivalent model may be generated will be described.

A wide variety of engineering and problems can be described by systems of algebraic or differential equations of the form:

$$N ( y , θ ) : θ \to y ( θ ) ≡ \{ \begin{matrix}f ( y , θ ) = 0 \\ \begin{matrix}\frac{ⅆ y}{ⅆ t} - f ( y , θ , t ) = 0 ; & y ( 0 ) = {y}_{0}\end{matrix}\end{matrix} \qquad ( 1 )$$

where N is a model that takes as input a set of m parameters θ={θ_{1, θ}₂, . . . , θₘ}, that
might include, for example, reaction rate constants, initial concentrations or stoichiometric coefficients and produces as output an n-dimensional vector of state variables y={y₁, y₂, . . . , yₙ} that may be typically associated with; for example, species concentrations. There are three essential levels at which the parameter vector θ influences the model predictions y(θ). The first and easiest is the solution of the model itself given a nominal set of parameter values \hat{θ}. There are numerous tools available to accomplish this task (e.g., Kee et al. 1996). A slightly harder problem is to assess the sensitivity, S, of differential changes in y around a nominal point \hat{θ}. In this case both the model (1) and the system of adjoint sensitivity equations:

$$S = {s}_{ij} = \frac{\partial y}{\partial θ} {\vert}_{\hat{θ} , y ( \hat{θ} )} ⇒ \{ \begin{matrix}\frac{\partial f}{\partial y} \frac{\partial y}{\partial θ} - \frac{\partial f}{\partial θ} = 0 \\ \begin{matrix}\frac{ⅆ}{ⅆ t} \frac{\partial y}{\partial θ} - \frac{\partial f}{\partial y} \frac{\partial y}{\partial θ} - \frac{\partial f}{\partial θ} = 0 ; \\ {S}_{0} = \frac{\partial y}{\partial θ} {\vert}_{0} = \{ \begin{matrix}0 & if {θ}_{j} \neq {y}_{i} ( 0 ) \\ 1 & if {θ}_{j} = {y}_{i} ( 0 )\end{matrix}\end{matrix}\end{matrix} \qquad ( 2 )$$

must be solved. Again, there are robust methods (e.g., Kee et al. 1996; Dunker 1984, Kramer et al. 1984) for solving (1) and (2) and, once the sensitivities have been found, they can be used to rank the relative importance of different parameters. (See, for example, Gao et al. 1995). The third, and most difficult, level, is to determine the global response of the model when the parameters are varied over a much wider range. In practice, not all values of the parameters may be equally likely, and the challenge is to combine the model response with the parameter variability.

FIG. 3A more clearly illustrates this challenge. Depending on the choice of nominal value \hat{θ}, the local sensitivities S can have different signs and, at the point where the parameter has its most likely value, the model response may not be very sensitive. The problem of determining the distribution of possible outcomes y(θ) given the uncertainty is more complex. If the probability density function of the input parameters is described by the joint probability distribution f_{θ}(θ) (illustrated in FIG. 3B), then what is needed is the distribution of the predicted outputs. Unfortunately, except for the simplest cases, there no simple way to find this distribution.

As a way of illustrating some of the complexities associated with incorporating uncertainties consider a simple first chemical decay of the form A [symbol] with a reaction rate k. The kinetics of the concentration of a species A can be described by a first order differential equation:

$$\begin{matrix}\frac{ⅆ y ( t )}{ⅆ t} = - {k}_{0} y ( t ) ; & y ( 0 ) = {y}_{0}\end{matrix} \qquad ( 3 )$$

where y₀ is the initial condition. For this very simple case the solution and the associated sensitivity are given by:

$$\begin{matrix}y ( t ) = {y}_{0} {ⅇ}^{- k t} & ( 4 ) \\ S = \frac{ⅆ y}{ⅆ k} {\vert}_{k} = - t {y}_{0} {ⅇ}^{- k t} & ( 5 )\end{matrix}$$

If k is an uncertain variable described by normal probability distribution with mean of k₀ and standard deviation k₁ i.e. k˜N[k₀, k₁] then the probability density function f_{y(k,t)}[y(k,t)] of the solution for y(k,t), when k is constant throughout the solution, but uncertain, can be found analytically:

$$\begin{matrix}{f}_{y ( k , t )} = \frac{1}{{k}_{1} t y ( k , t ) \sqrt{2 π}} \text{exp} ( - \frac{1}{2} {\{ \frac{ln \frac{y ( k , t )}{{y}_{0}} + {k}_{0} t}{{k}_{1} t} \}}^{2} ) ; \\ 0 < y ( k , t ) < ∞\end{matrix} \qquad ( 6 )$$

Quite clearly even though the parameter value is normally distributed the density function for the solution is lognormal. Given the probability distribution function f it is possible to characterize the uncertainty in terms of the moments. For example, the expected value or mean of y(θ) is given by (see Papoulis, 1991):

$$\begin{matrix}E [ y ( θ ) ] = {\int }_{- ∞}^{+ ∞} y ( θ ) {f}_{y ( θ )} [ y ( θ ) ] ⅆ y ( θ ) \\ = \underbrace{\int ⋯ \int }_{θ} y ( θ ) {f}_{θ} ( θ ) ⅆ {θ}_{1} … ⅆ {θ}_{m}\end{matrix} \qquad ( 7 )$$

and the r-th central moments by

$$\begin{matrix}{cm}_{r} = E [ {\{ y ( θ ) - E [ y ( θ ) ] \}}^{r} ] \\ = \underbrace{\int ⋯ \int }_{θ} {\{ y ( θ ) - E [ y ( θ ) ] \}}^{r} {f}_{θ} ( θ ) ⅆ {k}_{1} … ⅆ {k}_{m}\end{matrix} \qquad ( 8 )$$

For the particular case (6) the expected value is given by:

$$E [ y ( k , t ) ] = {\int }_{0}^{∞} y ( k , t ) {f}_{k} ( k ) ⅆ k = {y}_{0} {ⅇ}^{( - {k}_{0} t + \frac{1}{2} {k}_{1}^{2} {t}^{2} )} \qquad ( 9 )$$

There are several points that can be drawn from this example. The first is that solution using the mean value of the rate constant is not the same as the expected value i.e. y₀e^{-k}^{₀}^{t}≠E[y(k,t)]. Of even more relevance is that as soon as t≧2k₀/k₁² then the solution for the expected value of the concentration has an exponential increase. The reason for this is that when a normal distribution is used to describe the uncertainty in the rate there is a finite probability that the rate can become negative. In practice considerable care must be given to the choice of the parameter distributions to ensure that any sample has a physically realistic value.

If the analytic solution to f_{y(θ)}[y(θ)] is not available then the key practical problem in characterization of uncertainties is evaluating the multi-dimensional integrals (7-8). A wide variety of methods have been developed and one of the simplest is the classical Monte Carlo method where the multi-dimensional integral is replaced by a finite summation of the form:

$$E [ y ( θ ) ] = \underbrace{\int ⋯ \int }_{θ} y ( θ ) {f}_{θ} ( θ ) ⅆ {θ}_{1} … ⅆ {θ}_{m} \approx \frac{1}{{N}_{s}} {\sum }_{i = 1}^{{N}_{s}} y ( {θ}_{i} ) \qquad ( 10 )$$

where y(θᵢ) is the model prediction corresponding to the i-th sample point drawn from the distribution f_{θ}(θ) and Nₛ is the number of sample points needed to achieve statistically stable estimates of the moments. Although Monte Carlo methods (MCM) can be used for dealing with implicit models, these methods can be prohibitively expensive, especially when the computational cost is already high. Clearly alternative approaches, which can produce results at less computational cost, are of great interest.

Some of the methods that have been developed to treat this problem include the perturbation method (Lax, 1980), the method of moments (Morgan et al., 1992), Neumann expansions (Adomian, 1980; Ghanem and Spanos, 1991), the hierarchy method (Lax, 1980), the semi-group operator method (Serrano and Unny, 1990), and the spectral-based finite element method (Ghanem and Spanos, 1991). In order to use these methods the mathematical models must be explicit functions of the parameters and the equations must be readily for manipulation. For many practical problems these constraints can be very restrictive. Some of the sampling based methods that use solutions to the models that have been developed include the stratified or pattern search methods such as the Latin Hypercube Sampling (LHS) (McKay et al., 19769; Derwent, 1987), the Fourier Amplitude Sensitivity Test (FAST) (Cukier et al., 1973, 1975, 1978; McRae et al., 1982; Koda et al. 1979), and the Walsh amplitude sensitivity procedure (WASP) (Pierce and Cukier, 1981). In practice even using the best sampling procedures described in the previous section the number of runs needed to achieve stable statistics can be prohibitively expensive.

Traditionally, the approach to the treatment of uncertainty has been to first build the model and then probe its response by varying the parameters. An alternative approach is to integrate the uncertainty at the outset. In a classic paper Wiener (1938) developed the optimal representation of a random variable in terms of a series called a “polynomial chaos” expansion (PCE):

$$y ( ω ) = {\sum }_{i = 0}^{∞} {a}_{i} {H}_{i} [ {ξ}_{1} ( ω ) , {ξ}_{2} ( ω ) , ⋯ , {ξ}_{m} ( ω ) ] \qquad ( 11 )$$

where ω is the stochastic event, aᵢ are constant coefficients and Hᵢ are functionals whose m arguments are known probability density functions {ξ₁(ω), ξ₂(ω), . . . , ξₘ(ω)}. The polynomial chaos expansion, has the following four properties (Tatang, 1995): (1) Any square-integrable random variable can be approximated as closely as desired by a polynomial chaos expansion; (2) The polynomial chaos expansion is convergent in the mean-square sense; (3) The set of orthogonal polynomials is unique given the probability density function; (4) The polynomial chaos expansion is unique in representing the random variable. The probabilistic form (11) is analogous to a conventional Fourier series where a function is expanded in terms of a linear combination of sine and cosine basis functions. In practice only a finite number of terms M in (11) are used:

$$y ( ω ) \approx \hat{y} ( ω ) = {\sum }_{i = 0}^{M} {a}_{i} {H}_{i} [ {ξ}_{1} ( ω ) , {ξ}_{2} ( ω ) , ⋯ , {ξ}_{m} ( ω ) ] \qquad ( 12 )$$

Given the general form (12), the next steps are to define the functionals (Hᵢ), functions (ξ) and solve for the coefficients aᵢ of the finite expansion. The simplest way to determine the aᵢ^{'s} is to use the method of weighted residuals (MWR) (See, for example, Villadsen and Michelsen, 1978). The weighted residual is defined as the difference between the exact solution and the result when the series expansion is substituted into the model. For the general form (1) the j-th weighted residual is given, after a suitable change of variables from θ→ξ by
Rⱼ(ξ)={N[ŷ(ξ)]ŷ(ξ)−f(ξ)}Wⱼ(ξ);j=1, 2, . . . , m (13)
where Rⱼ(ω) is the j-th residual and the Wⱼ(ω) are weighting coefficients associated with each of the uncertain parameters in the model. If the expansion ŷ(ξ) satisfies (13) exactly then the residual is zero. Depending on the choice of weighting function and minimization method used to find the coefficients aᵢ the method is known as a least squares, Galerkin, or collocation based MWR schemes.

In this case the coefficients aᵢ are determined by setting the residual to be orthogonal to the space spanned by the probabilistic basis functions used in the expansion. The probabilistic form of the inner product of the residual and the weighting function, Wₖ(ξ), is set to zero:

$$\begin{matrix}E [ 〈 {R}_{j} , {W}_{k} 〉 ] = {\int }_{- ∞}^{+ ∞} ⋯ {\int }_{- ∞}^{+ ∞} {R}_{j} ( {ξ}_{1} , ⋯ , {ξ}_{m} ) {W}_{k} ( {ξ}_{1} , ⋯ , {ξ}_{m} ) \\ {f}_{ξ} ( {ξ}_{1} , ⋯ , {ξ}_{m} ) ⅆ {ξ}_{1} ⋯ ⅆ {ξ}_{m} \\ = 0 ; \\ j , k = 1 , 2 , … , m\end{matrix} \qquad ( 14 )$$

The integral (14) is defined for each of the M+1 basis polynomials Hᵢ. Once the integrals have been evaluated the system of M+1 deterministic equations can then be solved simultaneously for the coefficients aᵢ. Two weighting functions are typically used in practice a Galerkin and a collocation formulation.:

$${W}_{k} ( {ξ}_{1} , … , {ξ}_{m} ) ≡ \{ \begin{matrix}{g}_{k} ( {ξ}_{1} , … , {ξ}_{m} ) & Galerkin \\ {δ}_{k} ( ξ - c ) & Collocation\end{matrix} \qquad ( 15 )$$

In the Galerkin case the orthogonal trial functions are used as the weighting functions. When collocation is used δⱼ(ξ−c) are Dirac delta functions which force the residual to vanish at the collocation points c={c₁, c₂, . . . , cₖ). While in either case the multi-dimensional integrals (14) need to be evaluated, careful choice of the functionals Hᵢ, the weighting functions Wₖ and the independent functions can considerably simplify the process.

Polynomial chaos expansions are “problem specific” because of the definition of orthogonality in stochastic systems. Similar to the concept of orthogonal vectors spanning the vector space, parameter specific orthogonal polynomials are derived such that their roots are spread over the high probability region of the parameter. Two stochastic functions gᵢ(ξ) and gⱼ(ξ) are orthogonal when their inner product, defined using the probability distribution of the stochastic variable ξ, vanishes The definition of orthogonal polynomials is:

$$\begin{matrix}{\int }_{x}^{} {g}_{i} ( ξ ) {g}_{j} ( ξ ) {f}_{ξ} ( ξ ) ⅆ ξ = {C}_{i} {δ}_{ij} , & {δ}_{ij} = \{ \begin{matrix}1 & if i = j \\ 0 & otherwise\end{matrix}\end{matrix} \qquad ( 16 )$$

where gᵢ(x) is the i-th order orthogonal polynomial. Note that the polynomials are derived solely from the probability density function of the model parameters. In general, problem-specific orthogonal polynomials can be derived by algorithms such as ORTHPOL, following the recurrence relations (Gautschi et al. 1994):
g₋₁(x)=0,
g₀(x)=1,
gₖ₊₁(x)=(x−αₖ)gₖ(x)−βₖgₖ₋₁(x),
k=0, 1, . . . , n (17)
where the coefficients αₖ, βₖ can be expressed in terms of the orthogonal polynomials following the Gram-Schmidt orthogonalization procedure:

$$\begin{matrix}{α}_{k} = \frac{〈 {xg}_{k} , {g}_{k} 〉}{〈 {g}_{k} , {g}_{k} 〉} & ( k \geq 0 ) \\ {β}_{0} = 〈 {g}_{0} , {g}_{0} 〉 & \\ {β}_{k} = \frac{〈 {g}_{k} , {g}_{k} 〉}{〈 {g}_{k - 1} , {g}_{k - 1} 〉} & ( k \geq 1 )\end{matrix} \qquad ( 18 )$$

The inner product used above is in the form of Riemann-Stieltjes integral

$$〈 {g}_{i} , {g}_{j} 〉 = {\int }_{ℜ}^{} {g}_{i} ( x ) {g}_{j} ( x ) ⅆ λ ( x ) \qquad ( 19 )$$

where the function λ(x) is the indefinite integral of the weighting function. Several different types of orthogonal expansions are summarized in Table 1.

TABLE 1

| Probability | Polynomial for | |
|---|---|---|
| Density Function | Orthogonal Expansion | Support Range |
| Gaussian distribution | Hermite | (−∞, +∞) |
| Gamma distribution | Laguerre | (0, +∞) |
| Beta or Uniform distribution | Jacobi or Legendre | Bounded such as |
| | | (0, 1) |

As an illustration of the process consider the simple case 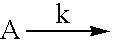
described earlier. The basic idea is to approximate y(t) using a polynomial expansion of the form:

$$A ( t ) ≃ \hat{y} ( t ) = {\sum }_{i = 0}^{n} {y}_{i} ( t ) {g}_{i} ( ξ ) \qquad ( 20 )$$

where the gᵢ(ξ) are the basis functionals and yᵢ(t) are the time varying coefficients in the expansion. For the particular case of Hermite polynomials the expansion is of the form:
y(t)=y₀(t)+y₁(t)ξ+y₂(t)(ξ²−1)+y₃(t)(ξ³−3ξ)+y₄(t)(ξ⁴−6ξ²+3)+ (21)

Applying the variational procedure described in the previous section produces a set of linear ordinary differential equations for the coefficients:

$$A \frac{ⅆ y ( t )}{ⅆ t} + By ( t ) = 0 \qquad ( 22 )$$

where A is the identity matrix and elements of B for the first four terms in the expansion is given by:

$$B = [ \begin{matrix}{k}_{0} & {k}_{1} & 0 & 0 \\ {k}_{1} & {k}_{0} & 2 {k}_{1} & 0 \\ 0 & {k}_{1} & {k}_{0} & 3 {k}_{1} \\ 0 & 0 & {k}_{1} & {k}_{0}\end{matrix} ] \qquad ( 23 )$$

The key point to note about (22) is that the equations for the uncertainty coefficients are of the same structural form as the original model and so its numerical solver can be used for both forms.

In the collocation approach the residual (14) is forced to vanish at cₖ, the collocation points thus satisfying the model exactly at ξ=c₁, ξ=c₂, . . . , ξ=c_{M+1}. For an M-th order polynomial chaos expansion, the collocation points {cₖ} are the roots of g_{M+1}(ξ). Collocation points are chosen in a manner analogous to the Guassian quadrature method for evaluating integrals. In the collocation method, instead of solving once a large system like (22), the deterministic model is solved M+1 times at each of the collocation points cₖ. The result is a set of M+1 deterministic equations for different Cₖ:

$$\begin{matrix}\hat{y} ( {c}_{1} ) = {\sum }_{i = 0}^{M} {y}_{i} ( t ) {g}_{i} ( {c}_{1} ) \\ … \\ \hat{y} ( {c}_{k} ) = {\sum }_{i = 0}^{M} {y}_{i} ( t ) {g}_{i} ( {c}_{k} ) \\ … \\ \hat{y} ( {c}_{M + 1} ) = {\sum }_{i = 0}^{M} {y}_{i} ( t ) {g}_{i} ( {c}_{M + 1} ) .\end{matrix} \qquad ( 24 )$$

After the model has been solved at each of the collocation points the set of simultaneous linear equations (24) can be solved for the coefficients y₀, . . . y_{M}. A key advantage of the collocation procedure is that it can be applied to “black box” type models where the model equations are not known explicitly because the method it requires only the solution of the model at specific values of the parameters.

This method, and the associated properties are completely generalizable to systems with many stochastic parameters. For example, if the parameters are independent:

$${f}_{ξ} ( {ξ}_{1} , {ξ}_{2} , … , {ξ}_{m} ) = {f}_{{ξ}_{1}} ( {ξ}_{1} ) {f}_{{ξ}_{2}} ( {ξ}_{2} ) … {f}_{{ξ}_{m}} ( {ξ}_{m} ) = {\prod }_{i = 1}^{m} {f}_{{ξ}_{i}} ( {ξ}_{i} ) \qquad ( 25 )$$

Assuming y is a function of N independent random variables, y=y(ξ₁, ξ₂, . . . , ξₘ), an M-th order polynomial chaos approximation y(ξ₁, ξ₂, . . . ξₘ) of y is written as:

$$\hat{y} ( {ξ}_{1} , {ξ}_{2} , … , {ξ}_{N} ) = {y}_{0} + {{\sum }_{i = 1}^{N} {y}_{i 1} {g}_{1} ( {ξ}_{i} )}_{linear} + {{\sum }_{i = 0}^{N} {y}_{i 2} {g}_{2} ( {ξ}_{i} )}_{second order} + {{\sum }_{i = 0}^{N} {\sum }_{j < i}}_{bilinear} {y}_{i 1 j 1} {g}_{i} ( {ξ}_{i} ) {g}_{j} ( {ξ}_{2} ) + {{\sum }_{i = 0}^{N}}_{third order} {y}_{i 3} {g}_{3} ( {ξ}_{i} ) + {{\sum }_{i = 0}^{N} {\sum }_{j < i} {y}_{i 2 j 1} {g}_{2} ( {ξ}_{i} ) {g}_{1} ( {ξ}_{j} )}_{second order in {ξ}_{i} , first in {ξ}_{j}} + {{\sum }_{i = 0}^{N} {\sum }_{j < i} {y}_{i 1 j 2} {g}_{1} ( {ξ}_{i} ) {g}_{2} ( {ξ}_{j} )}_{first order in {ξ}_{i} , second in {ξ}_{j}} + {{\sum }_{i = 0}^{N} {\sum }_{j \neq i} {\sum }_{k \neq j \neq i} {y}_{i 1 j 1 k 1} {g}_{1} ( {ξ}_{i} ) {g}_{1} ( {ξ}_{j} ) {g}_{1} ( {ξ}_{k} )}_{trilinear} + higher order terms . \qquad ( 26 )$$

The choice of collocation points for higher order system warrants further discussion. Unless all the cross product terms are included in the expansion, only selected collocation points will be used to determine the PCE coefficients. In order to handle this situation a formal procedure has been developed to choose systematically the collocation points used in the solution procedure. Consider first a two parameter case. The collocation points for each parameter are placed in order of decreasing probability. In the case when the probability is equal (e.g., in a uniform distribution), the points are organized in increasing distance from the mean. The first pair of points, which contains the most probable values for all the parameters among the collocation points (c₁, C₃), is termed the anchor point (ξ_{Anchor}). For each increasing order of approximation, the corresponding variable's collocation point is perturbed. Therefore, the pairs of points (c₁, C₃), (C₂, C₃), and (c₁, C₄) are chosen for an approximation which has a constant term and the first order terms in ξ₁ and ξ₂. If the there is a bilinear term g₁(ξ₁)g₁(ξ₂) is used in the approximation, the point (C₂, C₄) will also be used in the coefficient evaluation process.

Given the discussion in the previous section there is a clear need for an automatic procedure to simplify the choice of the appropriate numbers of terms in the expansion of the model output variables. Using an error correction mechanism embedded into most ordinary differential equations solvers the truncation error of the response surface representation is estimated by comparing the M-th order prediction to the (M+1)-th order prediction. The model is evaluated at the collocations points corresponding to the (M+1)-th order approximation and then the model solutions are compared to the approximation obtained from the M-th order PCE at those points. The error at each of the (M+1)-th order collocation points is defined as the square of the distance between the exact solution and the M-th order approximation:

$${ɛ}_{i} = {‖ {y}_{i} - {\hat{y}}_{i} ‖}^{2} \qquad ( 27 )$$

Two specific metrics are used; the sum square root (SSR) error and the relative sum square root (RSSR) error as:

$$\begin{matrix}SSR = \sqrt{\frac{{\sum }_{i = 1}^{M + 2} {f}_{ξ} {ɛ}_{i}}{( M + 2 ) {f}_{ξ} ( {ξ}_{anchor} )}} , \\ RSSR = \frac{ssr error}{E ( \hat{y} )} .\end{matrix} \qquad ( 28 )$$

The error measures in (28) can be used to guide the decision of whether more terms are needed in the PCE. The accuracy and number of terms required for the response surface approximation depends on the goal of the analysis. This procedure is implemented in a computer program that guarantees the convergence of the PCE series with increasing order. Interactions between the parameters can also be elucidated. The order of approximation is increased until the error is negligible. However, excessive number of model runs to evaluate coefficients sometimes can makes this approach computationally intensive. It is possible to analyze the error contribution from each of the variables by evaluating the individual terms, and select variables that contribute to the error as targets for higher order representation. Physical insights can also be used to guide the selection and use of cross product terms. One procedure for error control is shown in FIG. 3C

Once the coefficients in the polynomial chaos expansion have been determined there are several other useful properties than can be determined including the probability density function of the outputs, confidence intervals, moment information, and variance apportionment to identify the critical input variables. For example, one simple way to obtain the probability distribution of a response variable from the PCE representation is by Monte Carlo (MC) sampling of the expansion itself. In essence the PCE approximation can be viewed as a reduction of the original output variable. Where MC sampling of the original complex model is prohibitively expensive, MC sampling of a linear combination of algebraic terms containing the random input variables provides a viable alternative for understanding the behavior of the random output variable. This method can als be used to derive the cumulative density function (CDF). To generate a CDF, the output samples are sorted in ascending order and the limits of each fractile are recorded. The confidence intervals can also be determined using the sorted samples. For example, a 90% confidence interval will be the range of the empirical samples after the highest and lowest 5% of the samples are discarded. If a probability density function is needed, the range of the response variables is divided into bins or intervals and the frequency of occurrence in each interval is counted based on the same procedures used to generate histograms.

One application of particular importance is the determination of the moments of the output probability distribution and their application to the analysis of variance. The moments of the distribution can be determined empirically from the MC samples; or they can be calculated directly from the PCE coefficients, using the definition of the n-th central moment (cmₙ). The evaluation of moments is simplified by the orthogonal properties of the polynomials. For example, if:
y=u₀+u₁g₁₁(ξ₁)+u₂g₂₁(ξ₂), (29)
the mean value is equal to y₀, and the variance of the random variable is described by
σ²=A₁u₁²+A₂u₂²
A₁=∫g₁₁²(ξ₁)p_{ξ}(ξ₁)dξ₁, A₂=∫g₂₁²(ξ₂)p_{ξ}(ξ₂)dξ₂. (30)

Higher moments can also be determined from the coefficients of higher order terms. The relationship between the PCE coefficients and the variance suggests the utility of the PCE approximation for variance analysis. The contribution of each input parameter can be determined from the relevant terms in the approximation. In (30), the variance contribution (VC) from ξ₁ is A₁ u₁², while the VC from ξ₂ is A₂ u₂². Any cross terms are apportioned among the variables involved. This kind of analysis is particularly useful for identifying input variables whose uncertainties have strong effects on the uncertain outputs.

Consider an simple series reaction mechanism of the form 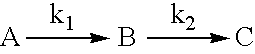
where k₁ and k₂ are uncertain parameters described by the normal distributions k₁=N[0.5,0.1] and k₂=N[2.0,0.5]. The initial conditions are [A(0)]=100, [B(0)]=[C(0)]=0. Once the reactions commence, the concentrations of A, B, and C are uncertain because of the uncertain rate constants. Set out below are the steps in applying the collocation procedure for uncertainty analysis.

Step 1. Specify Uncertain Parameters. In this example, the probability distributions of k₁ and k₂ are assumed to be independent and Gaussian. The polynomial chaos expansions are simply:
k₁=k₁₀+k₁₁ξ₁
k₂=k₂₀+k₂₁ξ₂ (31)
where k₁₀=0.5, k₂₀=2.0 are the mean values of k₁ and k₂, and k₁₁=0.1 and k₂₁=0.5 are the standard deviations. Methods for developing PCE forms for other probability distributions are described in Tatang (1995).

Step 2. Generate Problem-specific polynomial chaos expansions. Since the explicit forms of distributions of k₁ and k₂ are known, orthogonal polynomials chaos {gᵢ} can be generated such that the inner products, defined by ∫_{-∞}^{∞}gᵢ(ξ)gⱼ(ξ)f_{ξ}(ξ)dξ, are zero, where f_{ξ}(ξ) is the PDF of the uncertain variables ξ₁ or ξ₂. For standard normal distributions, the PCE are simply orthogonal Hermite polynomials defined by:
H₀(ξ)=1,
H₁(ξ)=ξ,
H₂(ξ)=ξ²−1,
H₃(ξ)=ξ³−3ξ
Etc. (32)

Step 3. Approximate Uncertain Outputs Using Polynomial Chaos Expansion. The model outputs, concentrations A (ξ₁,t), B(ξ₁, ξ₂,t), C(ξ₁, ξ₂,t), are expressed as linear combinations of the orthogonal polynomials determined in Step 2. These expressions are known as the polynomial chaos expansions (PCE) for the uncertain outputs, and to first order, are given by:

$$A = {{A}_{0}}_{constant} + {{A}_{1} {H}_{1} ( {ξ}_{1} ) + {A}_{2} {H}_{1} ( {ξ}_{2} )}_{linear terms} + {{A}_{3} {H}_{2} ( {ξ}_{1} ) + {A}_{4} {H}_{2} ( {ξ}_{2} )}_{second order terms} + {{A}_{5} {H}_{1} ( {ξ}_{1} ) {H}_{1} ( {ξ}_{2} )}_{bilinear term} + … \\ B = {B}_{0} + {B}_{1} {H}_{1} ( {ξ}_{1} ) + {B}_{2} {H}_{1} ( {ξ}_{2} ) + {B}_{3} {H}_{2} ( {ξ}_{1} ) + {B}_{4} {H}_{2} ( {ξ}_{2} ) + {B}_{5} {H}_{1} ( {ξ}_{1} ) {H}_{1} ( {ξ}_{2} ) + … \\ C = {C}_{0} + {C}_{1} {H}_{1} ( {ξ}_{1} ) + {C}_{2} {H}_{1} ( {ξ}_{2} ) + {C}_{3} {H}_{2} ( {ξ}_{1} ) + {C}_{4} {H}_{2} ( {ξ}_{2} ) + {C}_{5} {H}_{1} ( {ξ}_{1} ) {H}_{1} ( {ξ}_{2} ) + … \qquad ( 33 )$$

The concentrations of A, B, and C, and the coefficients, A₀, A₁, . . . , B₀, B₁, . . . , C₀, C₁, . . . are all functions of time. At each time point, the number of coefficients, hence the number of simultaneous equations for their solution, is determined by the order of the polynomial approximation. The higher the order of the approximation, the better the approximation. In practice the procedure is to start with a low order expansion and to increase the order iteratively as needed. Linear PCE representations for A, B, and C, using Hermite polynomials, are given by:
A(ξ₁,ξ₂,t)=A₀(t)+A₁(t)ξ₁+A₂(t)ξ₂
B(ξ₁,ξ₂,t)=B₀(t)+B₁(t)ξ₁+B₂(t)ξ₂
C(ξ₁,ξ₂,t)=C₀(t)+C₁(t)ξ₁+C₂(t)ξ₂. (34)

Step 4. Find the Collocation Points. Collocation points are selected to solve for the coefficients, A₀, A₁, A₂, B₀, B₁, B₂, C₀, C₁, and C₂, in the approximation (33). For a linear approximation, the collocation points are determined by the roots of the second order polynomial. H₂(ξ)=ξ²−1; therefore, ξ=±1. Since ξ₁ and ξ₂ are Gaussians and are symmetric about zero, the four pairs of collocation points (±1, ±1) are equal in probability and equal in distance to the mean (0, 0). The point (ξ₁, ξ₂)=(1, 1) is designated as the anchor point, the point with the highest probability. In this example, the points (−1, 1) and (1, −1) are also chosen. These correspond to (k₁, k₂) pairs of (k₁₀+k₁₁, k₂₀+k₂₁), (k₁₀−k₁₁, k₂₀+k₂₁), and (k₁₀+k₁₁, k₂₀−k₂₁), as listed in Table 2.

TABLE 2

| Points at Which to Solve Model | | |
|---|---|---|
| (k₁ = 0.5 ± 0.1 ξ₁ k₂ = 2.0 ± 0.5 ξ₂) | k₁ (ξ₁) | k₂ (ξ₂) |
| (c₁) - Anchor point | 0.6 (1) | 2.5 (1) |
| (c₂) - First perturbation of k₁ | 0.4 (−1) | 2.5 (1) |
| (c₃) - First perturbation of k₂ | 0.6 (1) | 1.5 (−1) |

Step 5. Solve the Model at the Collocation Points. The model is formulated to take the uncertain parameters k₁ and k₂ as external inputs. Solutions for A(t), B(t), and C(t) are evaluated for each pair of (k₁, k₂) found in Step 4. The original model solver is used “as is”, since the model equations are exactly satisfied at the collocation points.

Step 6. Solve for the Coefficients of Expansion from Model Results. The model solutions for A(t), B(t), and C(t) are equated to simple algebraic equations in (27) for each of the collocation points (k₁, k₂) listed in Table 2. The resulting time-dependent equations for the coefficients A₀, A₁, A₂, B₀, B₁, B₂, C₀, C₁, and C₂ are evaluated numerically at the selected time points. At each time point, the algebraic equations (24) are solved simultaneously for the unknowns. Since the concentration of A does not depend on the uncertain rate constant k₂, the coefficient A₂(t) in is exactly zero at all times.

Step 7 Estimate the Error of Approximation. The error of the linear PCE can be evaluated for each species at any given time based on the solutions at the roots of the third order Hermite polynomial (collocation points for the second order PCE). The roots to the third order approximation are ξ=0, ±\sqrt{3} and the corresponding points for each parameter combination are shown in Table 3 for a second order approximation.

TABLE 3

| Points at Which to Solve Model | | |
|---|---|---|
| (k₁ = 0.5 ± 0.1 ξ₁ k₂ = 2.0 ± 0.5 ξ₂) | k₁ (ξ₁) | k₂ (ξ₂) |
| (c₄) - Anchor point | 0.5 (0) | 2.0 (0) |
| (c₅) - First perturbation of k₁ | 0.673 (\sqrt{3}) | 2.0 (0) |
| (c₆) - Second perturbation of k₁ | 0.327 (−\sqrt{3}) | 2.0 (0) |
| (c₇) - First perturbation of k₂ | 0.5 (0) | 2.866 (\sqrt{3}) |
| (c₈) - Second perturbation of k₂ | 0.5 (0) | 1.134 (−\sqrt{3}) |

An example error calculation is shown in Table 4 for species B at time 1.0 units (when the concentration of B is at its maximum).

TABLE 4

| | c₄ | c₅ | c₆ | c₇ | c₈ |
|---|---|---|---|---|---|
| Exact solution | 15.7065 | 18.9602 | 11.5320 | 11.6369 | 22.4998 |
| Approximate | 16.4583 | 19.5191 | 13.3975 | 10.4192 | 22.4974 |
| Solution | | | | | |
| Error at Point (cᵢ) | −0.7518 | −0.5589 | −1.8655 | 1.2177 | 0.0024 |
| Probability of | 0.1591 | 0.0356 | 0.0356 | 0.0356 | 0.0356 |
| Point | | | | | |

| | |
|---|---|
| Expected Value | 16.4583 |
| of B | |
| Error (RSSR) | 0.036 |
| Error (SSR) | 0.591 |

Table 5 shows that the relative error of the linear approximation of the response surface is about 4%.

TABLE 5

| | Number of | | |
|---|---|---|---|
| | Model Runs (Including | Error | Error |
| Approximation Order | error evaluation) | (RSSR) (%) | (SSR) |
| 1 | 8 | 3.64 | 0.591 |
| 2 (square terms only) | 12 | 1.69 | 0.271 |
| 2 (complete) | 14 | 0.87 | 0.139 |
| 3 (complete) | 22 | 0.12 | 0.019 |
| 4 (complete) | 32 | 0.02 | 0.004 |
| 5 (complete) | 44 | 0.003 | 0.0005 |

This percentage number by itself is not an absolute measure of the “goodness” of the approximation. When the expected value is close to zero, the RSSR can grow in an unbounded manner and caution should be used in interpreting the error estimates.

Step 8. Increase the Order of Approximation. One way to decrease the error of the response surface approximation, and hence of the uncertainty estimates, is to increase the order of the polynomial chaos approximation. Including higher order terms and cross product terms have the obvious utility of capturing curvature of the response surface better. There is an additional advantage. Based on the choice of collocation points, as described in Step 4, increasing the number of terms also increase the “spatial coverage” of the collocation points, making the estimate applicable over a wider range of values of the uncertain inputs. The errors associated with different orders of approximation for the concentration of B at time=1 are presented in Table 5.

Step 9: Variance Analysis. Using the formulation described in (29-30) the mean and the variance, of the spread, of the response are of particular interest. FIG. 3C shows the expected values of the uncertain output concentrations A, B, and C with error bars representing the standard deviation of the PDF estimate. The solid lines are the nominal solution, that is, the deterministic solution calculated using k₁=0.5 and k₂=2.0, the best estimate of the input rate constants. The contribution to the total variance from each of the parameters is also shown in FIG. 3C. Several points are worth noting. First, the expected values are not always equal to the nominal solution based on the best estimates of k₁ and k₂. In fact, the expected solution in an uncertainty analysis can deviate significantly from the nominal solution in complex and highly non-linear mechanisms. Second, output uncertainties do not always increase with time. In this example, the initial condition are certain, and uncertainties of the concentrations at the beginning of the simulation are small. Since all reactions are irreversible, the end point is also certain: A and B disappear, and C asymptotically approaches the initial concentration of A due to the conservation of mass. This explains the decrease of uncertainties towards the end of the simulation. The transient portion of the reaction is most uncertain for all three species, indicating the uncertainties of the exact timing of the reactions and the concentration profiles. Uncertainties of the three species are inter-related, because total mass is certain and conserved. When compounds A and B are depleted, the concentration of C is certain to approach the initial condition of A. When the concentrations of A and B are uncertain, C is bound to be uncertain as well.

From the individual PCE coefficients, the contribution of any particular uncertain parameter to the output variance can be calculated. The PCE coefficients give information regarding the “global sensitivity” of the response variable to the parameter. FIG. 3D depicts the variance analysis for the intermediate species B. Both k₁ and k₂ contribute to uncertainties in the concentrations of B. Although the uncertainty of k₂ is higher than that of k₁, both in absolute and relative terms, the variance contributions of k₂ is not always dominant. In the very beginning of the reaction, k₁ dominates the variance, reflecting the sensitivity of the concentration of B to the rate constant of the A→B reaction when the concentration of B is low. As B builds up, the rate of the B→C reaction increases. At this stage, the concentration of B becomes more sensitive to k₂ than k₁. The uncertainty in k₂ translates to concentration uncertainty of concentration of species B. Such analysies proves to be useful in identifying key input parameters that affect the uncertainties of the model predictions.

Another application of the polynomial chaos expansion represents the distribution of the response variable as a functional of the uncertain input parameters. Monte Carlo sampling procedures can be applied to sampling the polynomial chaos expansion to obtain the probability density function of the output. With this approach, the overhead computer resource required to run a Monte Carlo analysis is small compared to the time taken to solve the model at the collocation points. For example, a 39-term PCE takes 1.8 seconds to solve and sample. If the model takes two hours to run, a overhead time of several seconds is negligible, and the time savings of using DEMM instead of Monte Carlo is the ratio of the number of model runs needed for the two methods.

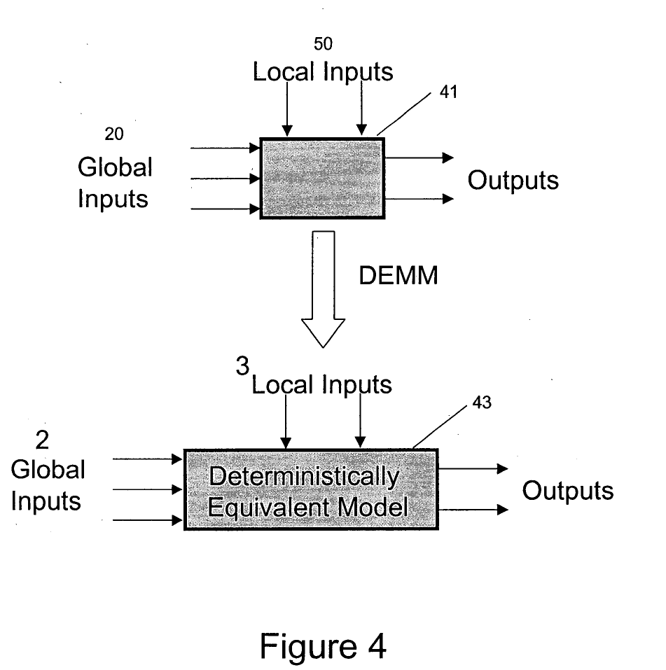

In a further embodiment, after increasing the order of the approximation, the algorithm may determine whether certain inputs may be ignored due to negligible uncertainty effect. In this manner, a reduced-order, deterministically equivalent model may be achieved. As indicated in FIG. 4, a module 41 having 20 global inputs and 50 local inputs may be represented by a deterministically equivalent model 43 having only 2 global inputs and 3 local inputs, for example. Thus, the modeling of the module 41 may be accomplished with greater efficiency while maintaining deterministic equivalence.

Once a deterministically equivalent model has been created for each module, the modules may communicate with each other while maintaining proper propagation of the input uncertainties.

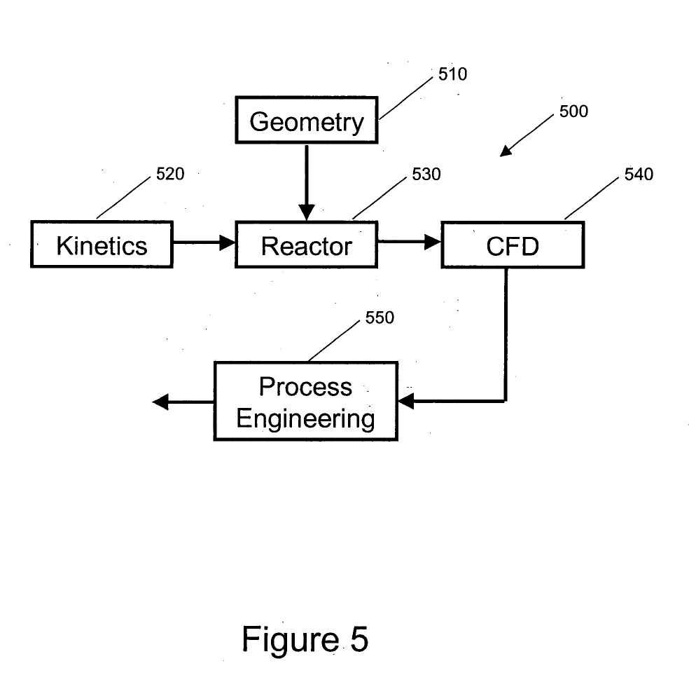

FIG. 5 illustrates a system 500 according to an exemplary embodiment of the invention for performing an integrated uncertainty analysis for a chemical reactor system. The system 500 may be an integrated collection of modules, each module being a simulation of a particular aspect of the system with system-specific inputs. A geometry module 510 may be provided to simulate the geometry of a chemical reactor. The geometry module 510 may be a commercially available software package for simulating structural geometry. A kinetics module 520 may be provided to simulate the kinetic interaction or movements of reactants involved in the chemical reactor system.

The geometry module 510 and the kinetics module 520 may provide inputs to a reactor model module 530 for simulating the reaction of the reactants in a chemical reactor. The reactor model may be a commercially available software package such as Chemkin. The reactor model module 530 may provide inputs to a computational fluid dynamics (CFD) module 540. The CFD module 540 may simulate the fluid dynamics of the reactants and products through a chemical reactor. A software package such as STARCD may be used to simulate the fluid dynamics. Outputs of one or more modules may be used to provide inputs to a process engineering module 550. Although FIG. 5 only illustrates outputs from the CFD module 540 being used for inputs into the process engineering module 550, inputs may be received directly from other modules such as the kinetics module 520 and the reactor module 530.

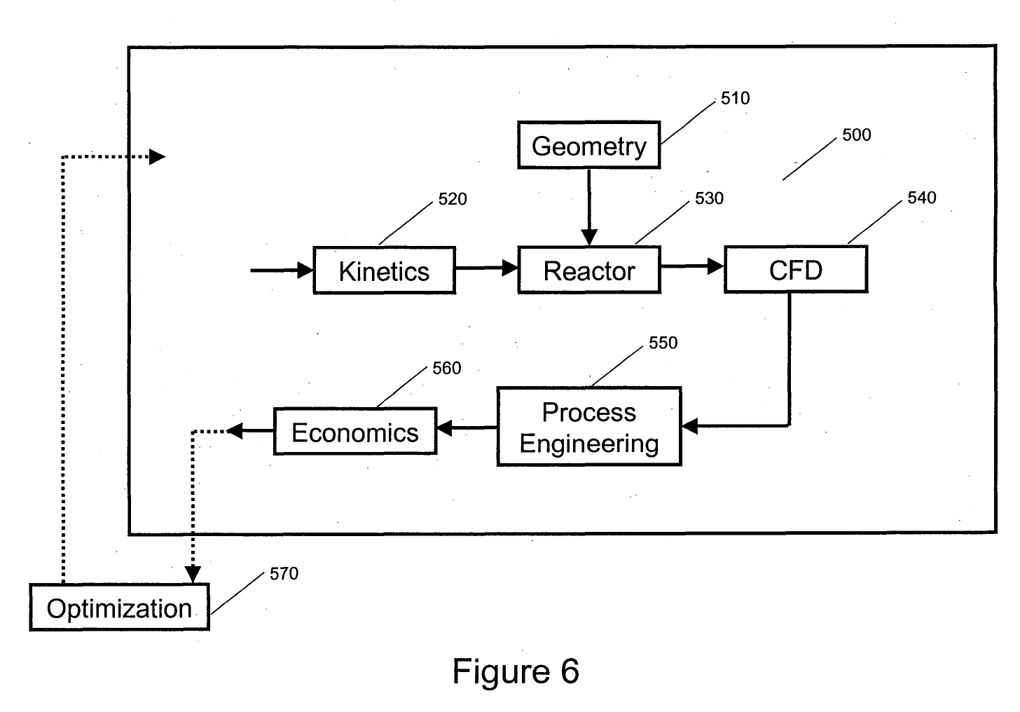

FIG. 6 illustrates a further embodiment of the system illustrated in FIG. 5. In the embodiment of FIG. 6, an economics module 560 is added to simulate the economic aspects of the design or design improvements of the reactor system. The economics module 560 may be a commercially available software package such as Icarus with system-specific inputs.

Further, an optimization module 570 may be incorporated to perform an optimization in the design of the reactor system. The optimization module 570 may also be a commercially available software package 570 and may include any of a variety of commonly known optimization algorithms, such as recursive quadratic programming or sequential quadratic programming. As indicated by the dotted lines in FIG. 6, the optimization module may perform an iterative optimization using the outputs of the chemical reactor system and by tweaking the inputs to the reactor system. The optimization performed by the optimization module may be used to accomplish any of several objectives such as, for example, determining an optimal resource allocation.

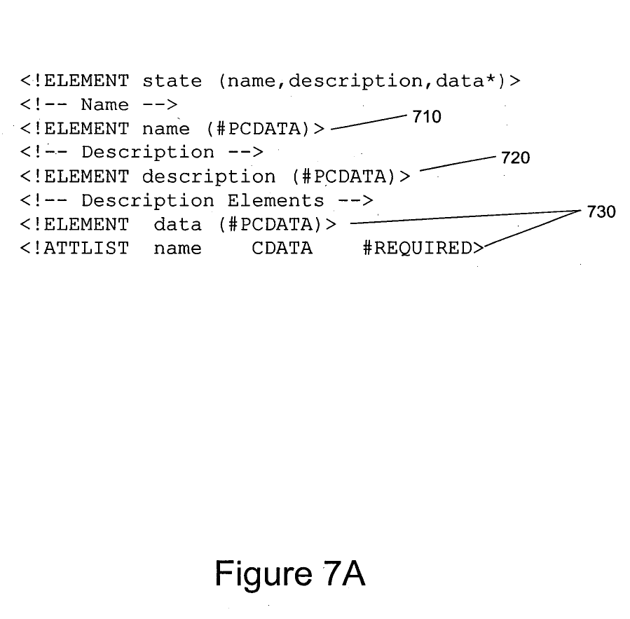

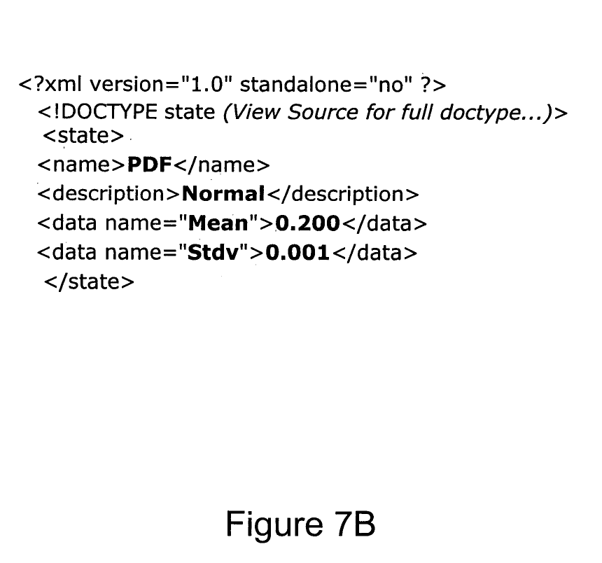

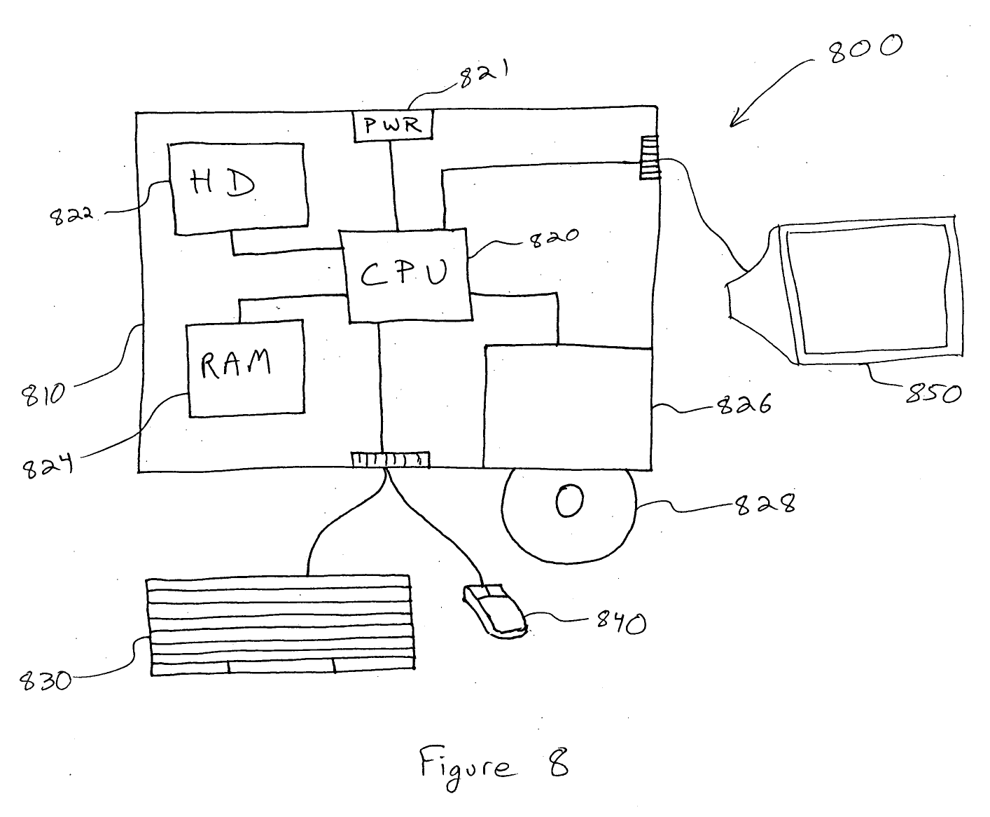

As seen from the illustrated systems of FIGS. 5 and 6, a system may include a variety of commercially available packages. Such packages often are not adaptable to interact with each other. For example, the output from the reactor model 530 using Chemkin may not be acceptable as input by the CFD module 540 using STAR CD. This problem may be further complicated by the need to communicate uncertainty information for the various parameters. To this extent, a common data architecture may be applied to allow the data and the uncertainties to be propagated between the various modules. One such data architecture using XML is described in U.S. Patent Application titled “METHOD AND APPARATUS FOR INFORMATION EXCHANGE FOR INTEGRATION OF MULTIPLE DATA SOURCES”, Attorney Docket No. 037010-0106, filed concurrently herewith and incorporated herein by reference in its entirety. FIGS. 7A and 7B illustrate an embodiment of a data architecture and an exemplary XML data file. The data architecture illustrated in FIG. 7A is adapted to accommodate any one of a group of uncertainty distributions. An element called “name” 710 is provided to identify the type of distribution for a particular variable. In the example illustrated in FIG. 7B, the “name” of the distribution is PDF, or probability density function. Another element called “description” 720 is provided to further describe the distribution. For example, in the example of FIG. 7B, several types of PDF distributions may be possible, including a “normal” distribution. Other PDF distributions may include exponential PDF distribution. Depending on the “name” and the “description” of the uncertainty distribution of the particular variable, one or more description elements may be provided to describe the actual distribution. In this regard, FIG. 7A illustrates the data architecture as including an attribute list 730 which is a function of the “name” and “description” parameters. For example, the example illustrated in FIG. 7B has a normal PDF distribution, requiring that the mean and the standard deviation be specified in order to completely describe the distribution.

Similarly, other uncertainty distribution types may be specified for each variable. For example, the uncertainty distribution of a variable having an exponential PDF distribution may be described by providing a mean value. Other distribution types that may be described using this common data architecture may include a polynomial chaos expansion, a list of points, or a histogram. Thus, the uncertainty distribution of each variable, input or output may be associated with the variable itself in, for example, a database.

The above-described methodology has been shown to use random variables. It is contemplated within the scope of the invention to allow utilization of random processes, for example, using Karhunen-Loeve series expansions, which are well known to those skilled in the art. For details on Karhunen-Loeve series expansions, reference may be made to Papoulis, A. Probability, Random Variables, and Stochastic Processes, 3rd Edition, McGraw Hill, N.Y., 1991, as well as to Tatang, M. A., Direct Incorporation of Uncertainty in Chemical and Environmental Engineering Systems, Ph.D. Thesis, Department of Chemical Engineering, Massachusetts Institute of Technology, Cambridge, Mass., 1995, each of which is hereby incorporated by reference.

With each module being able to effectively communicate its outputs to all other modules in a common data architecture, the optimization process may be automated.

In a further embodiment of the invention, the entire system of processes and subsystems may be modeled as a single system by creating a deterministically equivalent model, as described above for individual modules. In this regard, the global inputs into the system may now be treated as the inputs 10 illustrated in FIG. 1. With an equivalent model for each module, propagation of data and uncertainties through each module is assured, while the common data architecture ensures propagation between the modules. Thus, an integrated uncertainty analysis may be performed on an entire system with the system including all aspects of the design process, including economics, for example.

Although an embodiment of the invention is described above as being applied in the chemical environment, embodiments of the invention may be employed in a broad variety of applications. Some possible areas and industries for application include, without limitation, financial analyses, oil industry, various types of networks including computer networks, transportation, circuit simulation, project scheduling, and decision analysis.

For example, in the financial arena, when alternative investment proposals are considered, there are often many uncertainties to be considered including market size, selling price, financing availability, etc. If financial risk is to be managed effectively, it is critical to be able to assess the relative contributions of different sources of uncertainties. For example, in a net present value (NPV) calculation, there are often uncertainties in the future cash flows and the discount rate that, in turn, lead to uncertainties in the project valuation. Using a method or system for uncertainty analysis according to an embodiment of the present invention, it is possible to determine the NPV probability distribution and the contributions of individual terms to the variance in the valuation. Such information is important for developing risk mitigation strategies or to determine where additional resources might be allocated to reduce the overall risk. Similar analyses may be applied to a broad spectrum of financial instruments including options pricing, portfolio management, insurance pricing, etc.

An embodiment of the application may also be applied to the area of logistics and transportation networks. A common problem in managing the logistics of moving products from factories to warehouses to markets is to manage the shipping costs when there are uncertainties in customer demands, raw material suppliers and the availability of shipping capacity. The uncertainty analysis methods and systems according to embodiments of the present invention, together the mathematical programming formulations of the logistics problem, may be used to develop robust production schedules, inventory management policies and identify optimal ways to allocate shipping.

As a further example, an embodiment of the invention may be applied to simulations of electronic circuits. Electronic circuits are typically composed of many subsystems. At the lowest level, the components might be transistors, capacitors or resistors and, at a higher level of integration, the subsystems could be amplifiers or inverters. The electrical properties of these devices can be uncertain, which in turn leads to uncertainties in the overall system performance. Current circuit simulators, such as SPICE, cannot propagate effects of component uncertainties on determining the probability distribution of predicted outputs from the simulation model. The uncertainty analysis methods and systems according to embodiments of the present invention may treat the circuit simulator as a black box and identify component uncertainties that are influencing the outputs.

Mechanical and structural analyses may also employ embodiments of the present invention. Finite elements are widely used to study the statics and dynamics of complex systems made up of simple components. The uncertainty analysis methods and systems according to embodiments of the present invention may treat uncertainties in the external loadings and physical properties and determine how they affect the predictions of the numerical model. Embodiments of the present invention, in combination with Karhunen Loeve decomposition, can also account for spatial and temporal variations in the intake parameters.

Another example of an application of an embodiment of the invention is the analysis of decisions. Structuring and analyzing a complex decision involves many uncertainties. When models are used to describe the project elements, or there are uncertainties in decision outcomes, there is a need to identify the component parts that have the most influence on the outcomes. A knowledge of the probability density function of the outcomes as described above with reference to the embodiments of the present invention enables the investor to manage the risk across a portfolio of projects.

An embodiment of the invention may be implemented on a processor such as the computer system illustrated in FIG. 8. The computer system 800 comprises a computer such as a desktop unit 810 or a laptop. Processing is performed by a central processor unit (CPU) 820. The CPU 820 may receive electrical power from a power supply 821 connected to an external power source.

A hard drive 822 may be provided to store data and instructions in a non-volatile memory, for example. Further, a random access memory 824 is provided to temporarily store instructions for the CPU. The random access memory 824 may be provided with stored instructions by, for example, an executable residing on the hard drive 822 or on an external storage medium such as a floppy disk or a CD-ROM 828.

Information on the CD-ROM 828 may be accessed by the CPU 820 via a CD-ROM drive 826. Other drives may be provided to access information from other types of external storage media.

The CPU 820 may receive instructions, commands or data from an external user through input devices such as a keyboard 830 and a mouse 840. The CPU 820 may display status, results or other information to the user on a monitor 850.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

### References

Adomian, G., Stochastic system analysis, in Applied Stochastic Processes, edited by G. Adomian, pp. 1-17, Academic, San Diego, Calif., 1980.
Cukier, R. I., Fortuin, C. M., Shuler, K. E., Petschek, A. G., and Schaibly, J. H., Study of the sensitivity of coupled reaction systems to uncertainties in rate coefficients, I, Theory, J. Chem. Phys., 59, 3873-3878, 1973.
Cukier, R. I., Levine, H. B. and Shuler, K. E. Nonlinear sensitivity analysis of multi-parameter model systems, J. Chem. Phys., 26, 1-42, 1978.
Derwent, R. G., Treating uncertainty in models of the atmospheric chemistry of nitrogen compounds, Atmos. Environ., 21, 1445-1454, 1987.
Dunker, A. M., The Decoupled Direct Method for calculating sensitivity coefficients in chemical kinetics, J. Chem. Phys., 81(5), 2385-2303, 1984.
Gao, D, Stockwell, W. R. and Milford, J. B. “First order sensitivity and uncertainty analysis for a regional scale gas phase chemical mechanism, J. Geophysical Research, 100, 23,153-23,166, 1995.
Gautschi, W., Algorithm 726: ORTHPOL—A package of routines for generating orthogonal polynomials and Gauss-type quadrature rules, ACM Trans. Math. Software, 20(1), 21-26, 1994.
Ghanem, R. G. and Spanos, P. D., Stochastic Finite Elements; A Spectral Approach, Springer-Verlag, N.Y., 1991.
Kee, R. J., Rupley, F. M., Meeks, E. and Miller, J. A. , CHEMKIN-III: A Fortran Chemical Kinetics Package for the Analysis of Gas-Phase Chemical and Plasma Kinetics, Sandia National Laboratories Report SAND96-8216, 1996.
Koda, M., McRae, G. J. and Seinfeld, J. H., Automatic sensitivity analysis of kinetic mechanisms, Int. J. Chemical Kinetics, 11, 427-444, 1979.
Kramer, M. A., Rabitz, H., Calo, J. M., and Kee, R. J., Sensitivity analysis in chemical kinetics: Recent developments and computational comparisons, Int. J. Chem. Kinetics, 16, 559-578, 1984.
Lax, M. D., Approximate solution of random differential and integral equations, App. Stochastic Process, edited by G. Adomian, pp. 121-134, Academic, San Diego, Calif., 1980.
McKay, M. D., Beckman, R. J., and Conover, W. J. , A comparison of three methods for selecting values of input variables in the analysis of output from a computer code, Technometrics, 21, 239-245, 1979.
McRae, G. J., Tilden, J. W., and Seinfeld, J. H., Global sensitivity analysis—A computational implementation of the Fourier Amplitude Sensitivity Test (FAST), Comp. Chem. Eng., 6, 15-25, 1982.
Morgan, M. G., Henrion, M., and Small, M., Uncertainty, A Guide to Dealing with Uncertainty in Quantitative Risk and Policy Analysis, Cambridge University Press, New York, 1992.
Papoulis, A. Probability, Random Variables, and Stochastic Processes, 3rd Edition, McGraw Hill, N.Y., 1991.
Pierce, T. H. and Cukier, R. I., Global Nonlinear Sensitivity Analysis using Walsh functions, J. Comput. Phys., 41, 427-443, 1981.
Pan, W., Tatang, M. A., McRae, G. J. and Prinn, R. G., “Uncertainty Analysis of Direct Radiative Forcing by Anthropogenic Sulfate Aerosols, J. Geophysical Research, 102, (D18), 21,915-21,924, 1997.
Pun, B. K-L. Treatment of Uncertainties in Atmospheric Chemical Systems: A Combined Modeling and Experimental Approach, Ph.D. Thesis, Department of Chemical Engineering, Massachusetts Institute of Technology, Cambridge, Mass., 1997.
Serrano, S. E. and Unny, T. E., Random evolution equations in hydrogeology, Applied Mathematics and Computation, 39, 97s-122s, 1990.
Tatang, M. A., Direct Incorporation of Uncertainty in Chemical and Environmental Engineering Systems, Ph.D. Thesis, Department of Chemical Engineering, Massachusetts Institute of Technology, Cambridge, Mass., 1995.
Tatang, M. A., Pan, W., Prinn, R. G., and McRae, G. J. “An Efficient Method for Parametric Uncertainty Analysis of Numerical Geophysical Models, J. Geophysical Research, 102, (D18), 21,925-21,932, 1997.
Villadsen, J. and Michelsen, M. L., Solution of Differential Equation Models by Polynomial Approximation Prentice-Hall, N.J., 1978.
Wiener, N., The homogeneous chaos, Amer. J. Math., 60, 897-936, 1938.

1. A method of analyzing uncertainties in a system having at least two modules, comprising:
propagating an uncertainty distribution associated with each of a set of inputs through a module to produce an uncertainty in a set of outputs of said module;
generating a probabilistically equivalent model of said module, said equivalent model producing a model of said outputs; and
providing said model of said outputs in a common data architecture for use as inputs by any other module in said system.

2. The method according to claim 1, wherein said probabilistically equivalent model is a deterministically equivalent model.

3. The method according to claim 2, wherein said deterministically equivalent model is a reduced-order model.

4. The method according to claim 1, wherein said propagating said uncertainty distribution uses a Monte Carlo method.

5. The method according to claim 1, wherein at least one of said set of outputs is incorporated into at least one of said set of inputs in a feedback loop.

6. A method of analyzing uncertainties in a system, comprising:
substituting at least one of a plurality modules of a system with a corresponding probabilistically equivalent module model, said equivalent module model adapted to propagate uncertainties in inputs of said module to outputs of said module;
providing outputs of each of said modules in a common data architecture for use as inputs by any other module, said architecture adapted to propagate uncertainties in said outputs to said inputs of said other module; and
substituting said plurality of modules with a single probabilistically equivalent system model for propagating uncertainties in system inputs to system outputs.

7. The method according to claim 6, further comprising:
providing an optimization module for optimizing an objective function, said optimization module adapted to receive said system outputs and to vary said system inputs.

8. The method according to claim 7, wherein said objective function is a weighted function of two or more output parameters.

9. The method according to claim 6, wherein said probabilistically equivalent module model is a deterministically equivalent model.

10. The method according to claim 9, wherein said deterministically equivalent model is a reduced-order model.

11. The method according to claim 6, wherein said probabilistically equivalent system model is a deterministically equivalent model.

12. The method according to claim 11, wherein said deterministically equivalent model is a reduced-order model.

13. A system for generating an uncertainty analysis, comprising:
a module adapted to receive a set of inputs and to produce a set of outputs as a function of said inputs, each of said inputs having an associated uncertainty distribution;
means for propagating said uncertainty distribution of said inputs through said module to produce an uncertainty in said outputs;
means for generating a probabilistically equivalent model of said module, said equivalent model producing model outputs; and
means for providing said outputs in a common data architecture for use as inputs by any other module in said system.

14. The system according to claim 13, wherein said probabilistically equivalent model is a deterministically equivalent model.

15. The system according to claim 14, wherein said deterministically equivalent model is a reduced-order model.

16. The system according to claim 14, wherein said means for propagating said uncertainty distribution uses a Monte Carlo method.

17. A system of analyzing uncertainties in a system, comprising:
means for generating a probabilistically equivalent module model for at least one of a plurality modules of a system, said equivalent module model being adapted to propagate uncertainties in inputs of said module to outputs of said module;
means for providing outputs of each of said modules in a common data architecture for use as inputs by any other module, said architecture adapted to propagate uncertainties in said outputs to said inputs of said other module; and
means for generating a single probabilistically equivalent system model for said plurality of modules for propagating uncertainties in system inputs to system outputs.

18. The system according to claim 17, further comprising:
an optimization module for optimizing an objective function, said optimization module being adapted to receive said system outputs and to vary said system inputs.

19. The system according to claim 18, wherein said objective function is a weighted function of two or more output parameters.

20. The system according to claim 17, wherein said probabilistically equivalent module model is a deterministically equivalent model.

21. The system according to claim 20, wherein said deterministically equivalent model is a reduced-order model.

22. The system according to claim 17, wherein said probabilistically equivalent system model is a deterministically equivalent model.

23. The system according to claim 22, wherein said deterministically equivalent model is a reduced-order model.

24. A system for generating an uncertainty analysis, comprising:
a modeling module adapted to receive a set of inputs and to produce a set of outputs as a function of said inputs, each of said inputs having an associated uncertainty distribution;
an uncertainty propagation module adapted to propagate said uncertainty distribution of said inputs through said modeling module to produce an uncertainty in said outputs;
an equivalent model generation module adapted to generate a probabilistically equivalent model of said modeling module, said equivalent model producing said outputs; and
an output generation module adapted to provide said outputs in a common data architecture for use as inputs by any other module.

25. The system according to claim 24, wherein said probabilistically equivalent model is a deterministically equivalent model.

26. The system according to claim 25, wherein said deterministically equivalent model is a reduced-order model.

27. The system according to claim 24, wherein said uncertainty propagation module uses a Monte Carlo method.

28. A system of analyzing uncertainties in a system, comprising:
an equivalent model generation module adapted to generate a probabilistically equivalent subsystem model for at least one of a plurality of subsystems, said equivalent subsystem model being adapted to propagate uncertainties in inputs of said subsystem to outputs of said subsystem;
an output generation module adapted to provide outputs of each of said subsystems in a common data architecture for use as inputs by any other subsystem, said architecture being adapted to propagate uncertainties in said outputs to said inputs of said other subsystem; and
an equivalent system generation module adapted to generate a single probabilistically equivalent system model for said plurality of subsystems for propagating uncertainties in system inputs to system outputs.

29. The system according to claim 28, further comprising:
an optimization module for optimizing an objective function, said optimization module being adapted to receive said system outputs and to vary said system inputs.

30. The system according to claim 29, wherein said objective function is a weighted function of two or more output parameters.

31. The system according to claim 28, wherein said probabilistically equivalent subsystem model is a deterministically equivalent model.

32. The system according to claim 31, wherein said deterministically equivalent model is a reduced-order model.

33. The system according to claim 28, wherein said probabilistically equivalent system model is a deterministically equivalent model.

34. The system according to claim 33, wherein said deterministically equivalent model is a reduced-order model.

35. A program product, comprising machine readable program code for causing a machine to perform following method steps:
propagating an uncertainty distribution associated with each of a set of inputs through a module to produce an uncertainty in a set of outputs of said module;
generating a probabilistically equivalent model of said module, said equivalent model producing a model of said outputs; and
providing said model of said outputs in a common data architecture for use as inputs by any other module in said system.

36. The program product according to claim 35, wherein said probabilistically equivalent model is a deterministically equivalent model.

37. The program product according to claim 36, wherein said deterministically equivalent model is a reduced-order model.

38. The program product according to claim 35, wherein said propagating said uncertainty distribution uses a Monte Carlo method.

39. A program product, comprising machine readable program code for causing a machine to perform following method steps, comprising:
substituting at least one of a plurality modules of a system with a corresponding probabilistically equivalent module model, said equivalent module model adapted to propagate uncertainties in inputs of said module to outputs of said module;
providing outputs of each of said modules in a common data architecture for use as inputs by any other module, said architecture adapted to propagate uncertainties in said outputs to said inputs of said other module; and
substituting said plurality of modules with a single probabilistically equivalent system model for propagating uncertainties in system inputs to system outputs.

40. The program product according to claim 39, wherein said program code causes a machine to further perform the following method step, further comprising:
providing an optimization module for optimizing an objective function, said optimization module adapted to receive said system outputs and to vary said system inputs.

41. The program product according to claim 40, wherein said objective function is a weighted function of two or more output parameters.

42. The program product according to claim 39, wherein said probabilistically equivalent module model is a deterministically equivalent model.

43. The program product according to claim 42, wherein said deterministically equivalent model is a reduced-order model.

44. The program product according to claim 39, wherein said probabilistically equivalent system model is a deterministically equivalent model.

45. The program product according to claim 44, wherein said deterministically equivalent model is a reduced-order model.
